(19) United States
(12) Patent Application Publication
(10) Pub. No.: US 2012/0271718 A1
(43) Pub. Date: Oct. 25, 2012

(54) METHOD AND SYSTEM FOR PROVIDING BACKGROUND ADVERTISEMENT OF VIRTUAL KEY INPUT DEVICE

(76) Inventor: Hee Sung Chung, Seoul (KR)

(21) Appl. No.: 13/387,115

(22) PCT Filed: Oct. 5, 2011
(86) PCT No.: PCT/KR11/07355

§ 371 Date: Jan. 26, 2012

(30) Foreign Application Priority Data
Nov. 5, 2010 (KR) 10-2010-0109487

(51) Int. Cl. G06Q 30/02

(52) U.S. Cl. 705/14.58; 705/14.4

(57) ABSTRACT

Provided is a method for providing a background advertisement of a virtual key input device, which provides a background advertisement to a virtual key input device on an information communication terminal supporting a touch user interface (UTI). The method includes: generating a virtual key input unit; providing an advertisement contents skin as a background image of the virtual key input unit; and offering a reward in compensation for user's reading an advertisement.

### TECHNICAL FIELD

The present invention relates to a method and system for providing a background advertisement of a virtual key input device, which provides advertisement contents to a background region of a virtual key input device for touch input in an information communication terminal supporting a touch user interface (TUI), and offers a reward in compensation for user's reading an advertisement.

### BACKGROUND

Recently, among mobile information communication terminals such as smart phones and pad-type PCs and on-board-type information communication terminals such as navigation systems, the number of terminals supporting a touch user interface (TUI) has rapidly increased. The TUI displays various types of keypads (or keyboards) such as a Qwerty keyboard and a 12 keypad on a display screen. When a user touches a virtual keypad, the TUI recognizes the touched keypad as an input signal. Such a virtual key input device provides diversity of tools, and enables a user to freely select a device. Furthermore, terminals having the TUI mounted therein provide an intuitional user interface (UI). Therefore, although terminals having the TUI mounted therein are relatively expensive, they have high product competitiveness.

In the conventional terminals supporting the TUI, a virtual key input device is very frequently used to utilize a search window of an information search engine, a social network service (SNS), an e-mail service, or a multimedia message service (MMS). However, although a virtual keypad occupies a considerably large area of a display screen in the conventional terminals supporting the TUI, the background image of the keypad is provided as a single-color button. That is, the virtual keypad occupying a considerably large display space is provided in software. However, the display space has not been utilized for business purposes.

A typical mobile information communication terminal has a limited space which may be utilized for a business service. However, it is important for the recent business services to secure a space where an interactive service with a user may be performed. This is the latest technology field where UI technology aimed for realizing convenient writing and easy learning and UX technology aimed for satisfying writing pleasure and latent needs are merged.

Meanwhile, techniques for providing a background image include a technique related to ‘skin’. Korean Patent Laid-open Application No. 2003-0073957 discloses an apparatus and method for controlling skin modification as the technique related to ‘skin’. The apparatus for controlling skin modification is provided in a mobile communication terminal including a display device capable of displaying characters or symbols corresponding to the characters and a select keypad for selection, and includes an internal memory having an internal memory address area and an external memory address area, an external memory configured to store various skin data, and a controller configured to read skin data from the external memory and set the read skin data when a skin is selected in case where the external memory is mounted.

However, the conventional technique and the techniques related thereto do not provide a business mode based on UX, and have nothing to do with a virtual keypad provided by a TUI. This is because it is only a short time since information communication equipments such as smart phones emerged, and the development of techniques related to UX has not come to maturity.

### DISCLOSURE

### Technical Problem

An embodiment of the present invention is directed to a method and system for providing a background advertisement of a virtual key input device, which utilizes a background space of a virtual key input unit displayed by a TUI as an advertisement business space to provide user-customized or user-interactive advertisement contents, and offers a proper reward in compensation for reading an advertisement, thereby providing an economic benefit to a user who provides an unused space and creating a new model of the mobile advertisement business for an advertiser or advertisement service provider.

### Technical Solution

According to an embodiment of the present invention, there is provided a method for providing a background advertisement of a virtual key input device, which provides a background advertisement to a virtual key input device on an information communication terminal supporting a UTI. The method includes: generating a virtual key input unit; providing an advertisement contents skin as a background image of the virtual key input unit; and offering a reward in compensation for user's reading an advertisement.

The generating of the virtual key input unit may include: selecting a virtual key input unit; and generating a transparent skin input unit based on the selected virtual key input unit.

The selecting of the virtual key input unit may include: selecting a language of the virtual key input unit; selecting a key input method; and selecting a form of the virtual key input unit.

The generating of the transparent skin input unit may include: generating the selected virtual key input unit into a two-dimensional (2D) graphic frame; allocating character keys onto the 2D graphic frame and arranging the allocated character keys; and generating the 2D graphic frame having the character keys arranged therein into the transparent skin input unit.

The method may further include constructing a transparent skin input unit DB configured to store the transparent skin input unit.

The constructing of the transparent skin input unit DB may include: allocating a data attribute to each transparent skin input unit, the data attribute including one or more of language, input method, input unit form, production date, producer, and size; and storing the transparent skin input unit in the transparent skin input unit DB according to the data attribute.

The providing of the advertisement contents skin as the background image of the virtual key input unit may include: selecting advertisement contents; generating the selected advertisement contents into an advertisement contents skin of the virtual key input unit; and combining the virtual key input unit and the advertisement contents skin.

The combining of the virtual key input unit and the advertisement contents skin may include: loading the advertisement contents skin into a virtual key input unit region of a display screen of the information communication terminal; and loading a transparent skin input unit of the virtual key input unit, and combining the loaded transparent skin input unit and the advertisement contents skin.

The generating of the selected advertisement contents into the advertisement contents skin of the virtual key input unit may include: standardizing the selected advertisement contents according to the size of the virtual key input unit; adjusting the resolution of the advertisement contents according to the resolution of the user's information communication terminal; and generating the advertisement contents into the advertisement contents skin of the virtual key input unit.

The method may further include constructing an advertisement contents skin DB configured to store the advertisement contents skin.

The constructing of the advertisement contents skin DB may include: allocating a data attribute to each advertisement contents, the data attribute including one or more of advertisement name, advertisement producer, production date, contents media, size, copyright, contents form, and contents rating; and storing the advertisement contents skin in the advertisement contents skin DB according to the data attribute.

The advertisement contents may include a multimedia file containing pictures, photographs, animations, videos, or 3D video.

The selecting of the advertisement contents may include: confirming whether or not the user allows external advertisements to be posted on the virtual key input unit of the information communication terminal; receiving verification of the user; and providing, by an advertisement provider server, advertisement contents to the user.

The providing of the advertisement contents to the user may include a streaming method by a wired/wireless medium and a download method by a storage medium.

The method may further include any one or a combination of two or more of: selecting, by the user, advertisement contents provided by the advertisement provider server; providing, by the advertisement provider server, advertisement contents based on position information of the user; providing, by the advertisement provider server, advertisement contents based on activity information of the user; and providing, by the advertisement provider server, advertisement contents based on personal information of the user.

The selecting of the advertisement contents provided by the advertisement provider server may include: posing an advertisement area and contents in a metadata table form on the information communication terminal of the user; and selecting, by the user, metadata containing an advertisement area and contents.

The providing of the advertisement contents based on the position information of the user may include: collecting the position information from the information communication terminal of the user; and providing advertisement contents related to the position information to the user.

The providing of the advertisement contents based on the activity information of the user may include: collecting the activity information from the information communication terminal of the user; and providing advertisement contents related to the activity information to the user.

The providing of the advertisement contents based on the personal information of the user may include: collecting the personal information from the information communication terminal of the user; and providing advertisement contents related to the personal information to the user.

The offering of the reward in compensation for user's reading the advertisement may include: constructing an advertisement reading user DB configured to store information of the user which reads the advertisement; and constructing an advertisement reading compensation information DB configured to store compensation information which is to be provided to the user who reads the advertisement.

The constructing of the advertisement reading user DB may include allocating a data attribute to each user, the data attribute including one or more of a reading advertisement detail, a compensation detail, and a compensation date.

The constructing of the advertisement reading compensation information DB may include allocating a data attribute to each advertisement contents, the data attribute including one or more of an advertisement contents name, a read advertisement item, an advertisement reading number, a read date, and a compensation method.

The offering of the reward in compensation for user's reading the advertisement further may include: acquiring statistics for advertisement contents read by the user; posting compensation details on the information communication terminal of the user; and offering a compensation to the user.

The posting of the compensation details may include posting a plurality of compensation types and confirming a user's selection.

The plurality of compensation types may include two or more of coupon, cash, prize, and discount.

According to another embodiment of the present invention, there is provided a system for providing a background advertisement of a virtual key input device, which provides a background advertisement to a virtual key input device on an information communication terminal supporting a TUI. The system includes: a transparent skin input unit generator configured to generate a virtual key input unit into a transparent skin input unit; an advertisement contents skin generator configured to generate advertisement contents into an advertisement contents skin; and a skin combiner configured to combine the transparent skin input unit and the advertisement contents skin.

The transparent skin input unit generator may generate the virtual key input unit into a 2D graphic frame, and allocates character keys onto the 2D graphic frame to generate the transparent skin input unit.

The system may further include a transparent skin input unit DB configured to store and manage the transparent skin input unit such that the transparent skin input unit has a data attribute including one or more of language, input method, input unit form, production date, producer, and size.

The advertisement contents skin generator may generate the advertisement contents into a background advertisement contents skin of the virtual key input unit.

The advertisement contents skin generator may generate the background advertisement contents skin by standardizing the advertisement contents according to the size of the virtual key input unit and adjusting the resolution of the advertisement contents according to the resolution of the information communication terminal of the user.

The system may further include an advertisement contents skin DB configured to store and manage the advertisement contents skin such that the advertisement contents skin has a data attribute including one or more of advertisement name, advertisement producer, production date, contents media, size, copyright, contents form, and contents rating.

The advertisement contents may include a multimedia file containing pictures, photographs, animations, videos, or 3D videos.

The skin combiner may load the advertisement contents skin into a virtual key input unit region of a display screen of the information communication terminal, load the transparent skin input unit, and combine the transparent skin input unit and the advertisement contents skin.

The system may further include a combined skin DB configured to store and manage the combined skin formed by the skin combiner.

The system may further include: an advertisement provider server configured to provide the advertisement contents; and an advertisement reading compensator provided in the advertisement provider server and configured to offer a reward in compensation for user's reading an advertisement.

The advertisement provider server may provide the advertisement contents to the user using a streaming method by a wired/wireless medium or a download method by a storage medium.

The advertisement provider server may include a user-customized advertisement contents generator configured to enable the user to select advertisement contents.

The advertisement provider server may provide advertisement contents based on any one or a combination of two or more of position information, activity information, and personal information of the user.

The advertisement reading compensator may acquire statistics for advertisement contents read by the user and offer a compensation corresponding to the statistics.

The advertisement reading compensator may decide one or more compensation types among coupon, cash, prize, and discount according to the user's selection.

The system may further include an advertisement reading user DB configured to store and manage advertisement reading information of the user such that the advertisement reading information has a data attribute including one or more of read advertisement detail, compensation detail, and compensation date.

The system may further include an advertisement reading compensation information DB configured to store and manage compensation information for advertisement reading such that the compensation information has a data attribute including one or more of advertisement contents name, read advertisement item, advertisement reading number, read date, and compensation method.

### Advantageous Effects

According to the embodiments of the present invention, the method and system for providing advertisement contents of a virtual key input device provides a user-customized or user-interactive advertisement as a background image to a virtual keypad or keyboard which is touched most frequently when users utilize an information communication terminal supporting a TUI. Therefore, the method and system may maximize an advertisement effect by frequently exposing various types of advertisements to users. Furthermore, the method and system may enable the users to experience writing pleasure and UX technology and simultaneously guarantee an economic benefit. In addition, the method and system may create a new business model for the mobile advertisement business.

### BRIEF DESCRIPTION OF THE DRAWINGS

FIG. 1 is a block diagram of a system for providing a background advertisement of a virtual key input device according to an embodiment of the present invention.

FIG. 2 is a block diagram of a system for providing a background advertisement of a virtual key input device according to another embodiment of the present invention.

FIG. 3 is a flow chart showing a process of generating a transparent skin input unit of a virtual key input unit.

FIGS. 4A and 4B illustrate a process of generating a transparent skin input unit.

FIG. 5 shows a process of generating an advertisement contents skin from advertisement contents.

FIG. 6 shows a process of combining a transparent skin input unit and an advertisement contents skin.

FIG. 7 is a flow chart showing a process of selecting advertisement contents.

FIG. 8 illustrates an example in which the method for providing advertisement contents of a virtual key input device according to the embodiment of the present invention is performed in an Android-based smart phone.

FIG. 9 is a flow chart showing a process of offering a reward in compensation for advertisement reading.

FIG. 10 is a flow chart showing a process in which a user selects a compensation method.

FIGS. 11A to 11D show memory tables including record attributes of DB systems.

FIGS. 12A to 12D show examples in which advertisement contents skins are utilized as background images of a virtual key input unit.

### BEST MODE FOR THE INVENTION

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

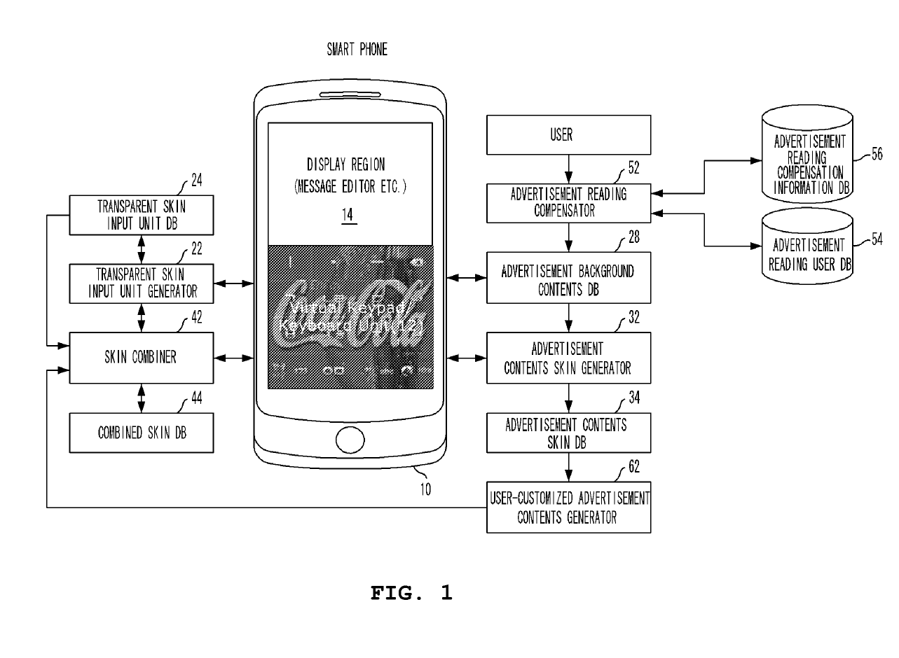

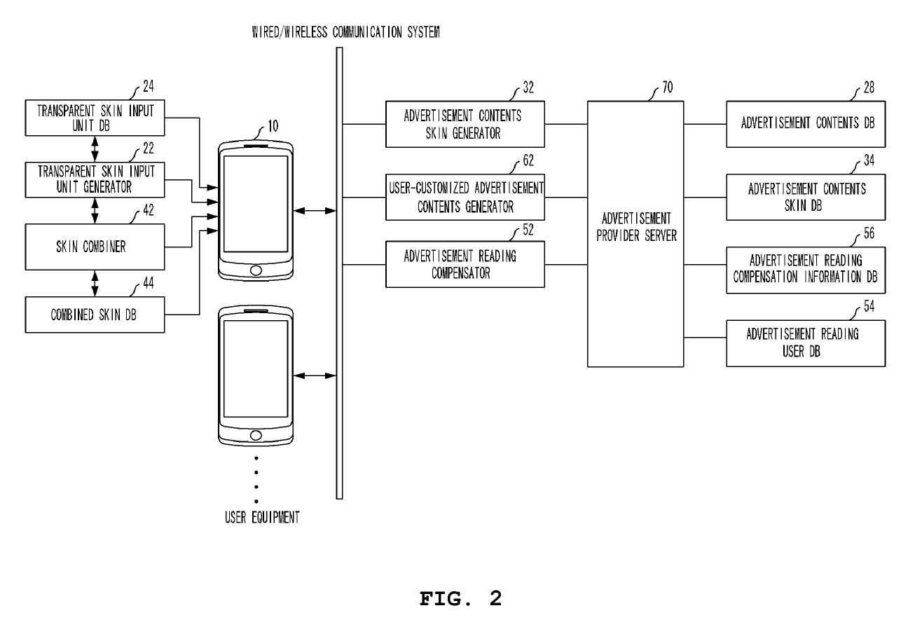

FIG. 1 is a block diagram of a system for providing a background advertisement of a virtual key input device according to an embodiment of the present invention, illustrating a system architecture implemented by using a smart phone. FIG. 2 is a block diagram of a system for providing a background advertisement of a virtual key input device according to another embodiment of the present invention. FIG. 2 illustrates an example in which a smart phone and an advertisement provider server form the system through a wired/wireless communication system.

In the following descriptions, ‘virtual key input device’ refers to a keypad or keyboard which is displayed in software by a TUI. For example, the keypad or keyboard includes a Qwerty keyboard, a 12-number or character keypad, a number input key pad for telephone dialing and so on. In this embodiment of the present invention, the virtual key input device is provided as a transparent skin. Hereinafter, this will be referred to as ‘transparent skin input unit’. Furthermore, advertisement contents are standardized to form an advertisement contents skin which is to be displayed on an information communication terminal such as the smart phone 10, and the advertisement contents skin is combined with the transparent skin input unit and then displayed on the smart phone 10. Hereinafter, a skin obtained by standardizing advertisement contents according to the information communication terminal is referred to as ‘advertisement contents skin’, and a skin obtained by combining a transparent skin input unit and an advertisement contents skin is referred to as ‘combined skin’.

Referring to FIG. 1, the system for providing advertisement contents of a virtual key input device according to the embodiment of the present invention includes a transparent skin input unit generator 22, an advertisement contents skin generator 32, and a skin combiner 42 configured to combine a transparent skin input unit and an advertisement contents skin. The system may further include a user-customized advertisement contents generator 62.

Here, components such as ‘˜generators’ refer to components which play specific roles and are implemented in graphic processing software on an external PC or information communication terminal. Meanwhile, ‘˜generator’ may refer to a hardware component such as field-programmable gate array (FPGA) or application specific integrated circuit (ASIC). As such, ‘˜generator’ is not limited to software or hardware. For example, ‘˜generator’ may be constructed in a storage medium, and may be configured to drive one or more processors. For example, ‘˜generator’ may include certain processes, functions, sub routines, segments of a program code, firmware, microcode, a database, and variables.

The transparent skin input unit generator 22 serves to generate character keys for inputting a specific language (for example, Korean, English, Alphabet, universal character set, symbol, and number) designated by a user and a two-dimensional (2D) figure having frame data of the character keys. When the language and standard of a virtual key input unit are decided by a user, the transparent skin input unit generator 22 generates the virtual key input unit into a transparent skin input unit. The generated transparent skin input unit is stored in and managed by a transparent skin input unit DB 24. The transparent skin input unit DB 24 includes data attributes, such as language, input method, input unit form, production date, producer, and size, for each input unit. The transparent skin input unit DB 24 and ‘˜DB’ which will be described below may be implemented by using a typical DB system, and may be implemented in the form of gallery photo files provided by the smart phone 10.

The advertisement contents skin generator 32 serves to generate advertisement contents in a background skin form according to the size and shape of a virtual key input device. The advertisement contents skin generator 32 may be implemented in graphic processing software which is installed in an information communication terminal and configured to process advertisement contents provided from outside into a background skin form. The advertisement contents may be streamed or downloaded in real time. Furthermore, referring to FIG. 2, the advertisement contents skin generator 32 may be provided in an external advertisement provider server 70 and configured to generate and provide an advertisement contents skin suitable for a user's smart phone 10. FIG. 1 illustrates that the advertisement contents skin generator 32 is provided in the smart phone 10, and FIG. 2 illustrates that the advertisement contents skin generator 32 is provided in the advertisement provider server 70.

An advertisement contents DB 28 is used to store advertisement contents. Desirably, the advertisement contents DB is a DB system provided in an advertiser or advertisement service provider side (hereinafter, commonly referred to as ‘advertisement provider’). Advertisement contents include multimedia files containing pictures, photographs, animations, videos, or 3D videos. The advertisement contents DB 28 stores various types of advertisement contents according to various attributes for each advertiser, each advertisement type, each contents form, and each advertisement rating.

A user may access a wireless Internet connection and download advertisement contents, using the smart phone 10. Furthermore, the user may temporarily store and manage a list of advertisement contents which are provided by the advertisement provider server 70 in real time. Among the advertisement contents stored in the advertisement contents DB 28, advertisement contents which are selected and downloaded by the user or advertisement contents which are authenticated by the user and then designated by an advertisement provider are generated as a background skin suitable for a terminal by the advertisement contents skin generator 32. The generated advertisement contents skin is stored in and managed by an advertisement contents skin DB 34. The advertisement contents skin DB 34 has data attributes including advertisement name, advertisement producer, production date, contents media, size, copyright, contents form, and contents rating for each advertisement contents.

The skin combiner 42 is configured to combine a 2D-figure transparent skin input unit 23 generated by the transparent skin input unit generator 22 and an advertisement contents skin 33 generated by the advertisement contents skin generator 32, and form a combined skin 43. The transparent skin input unit 23 has only frame data of character keys. For example, the skin combiner 42 is implemented in graphic software and provided in the smart phone 10. The combined skin 43 formed by the skin combiner 42 is stored in and managed by a combined skin DB 44. Referring to FIG. 1, the smart phone 10 includes a lower region for displaying the combined skin 43 and an upper region 14 for displaying an editor such as a message editor.

An advertisement reading compensator 42 serves to offer a reward in compensation for advertisement reading. The advertisement reading compensator 42 may be provided in the advertisement provider server 70. The advertisement reading compensator 42 provides an economic benefit such as coupon, cash, prize, or discount, based on an advertisement reading time and an advertisement reading number of a user. The advertisement provider server 70 includes an advertisement reading user DB 54 and an advertisement reading compensation information DB 56, in order to offer a compensation for advertisement reading. The advertisement reading compensator 42, the advertisement reading user DB 54, and the advertisement reading compensation information DB 56 will be described below in detail.

The user-customized advertisement contents generator 62 serves to search and extract advertisement contents selected by a user from the advertisement contents skin DB 34. The user-customized advertisement contents generator 62 is executed by a user's selection and may be installed in the user's smart phone 10 or the advertisement provider server 70.

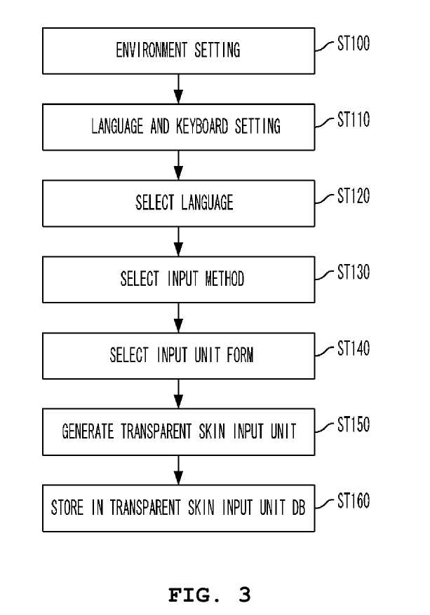

FIG. 3 is a flow chart showing a process of generating a transparent skin input unit of a virtual key input unit. FIG. 3 shows a process of selecting a virtual key input unit in the smart phone 10. In the smart phone 10, environment settings for character input are collectively managed by a menu referred to as ‘Settings’. As a user executes ‘Settings’, the process is started at step ST100. Then, language and keyboard setting of a virtual key input unit (by a TUI) is performed in the environment setting mode, at step ST110. Here, the user selects a language of the virtual key input unit at step ST120, and selects an input method at step ST130.

The input method may include various input methods such as a full keyboard, a 12-key pad, and a hand-writing input system. The full keyboard may include a Qwerty keyboard, and the 12-key pad may include a telephone pad. When the input method is selected, the user selects the shape of the virtual key input unit at step ST140. The virtual key input unit may include a horizontal virtual keypad, a vertical virtual keypad, a full Qwerty keyboard, or a 12-key number pad.

When the shape of the virtual key input unit is selected, a transparent skin input unit is generated based on the selected shape at step ST150. Furthermore, the generated transparent skin input unit is stored in a transparent skin input unit DB 24.

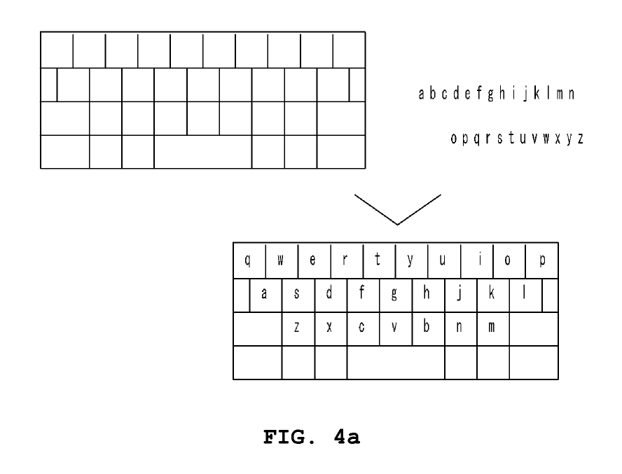

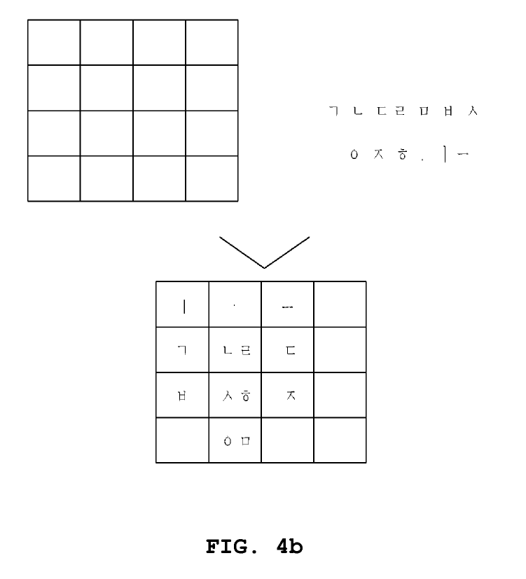

FIGS. 4A and 4B illustrate a process of generating a transparent skin input unit. The transparent skin input unit generator 22 generates a Qwerty keyboard-type transparent skin input unit 23 as illustrated in FIG. 4A or a 4×4 keypad-type transparent skin input unit 23 as illustrated in FIG. 4B. The transparent skin input unit 23 is constructed in a 2D arrangement. That is, the transparent skin input unit 23 includes graphic data where boundaries for dividing character keys and function keys are clearly represented and the other regions are transparent.

More specifically, the size of the virtual key input unit is set to ‘horizontal pixel number*vertical pixel number’, and the virtual key input unit is generated as 2D graphic data. The generated 2D graphic data are processed by the unit of key arrangement, and lines are drawn according to the shape of the virtual key input unit. Subsequently, graphic processing is performed to insert characters or symbols of function keys into the respective key arrangements, and the other regions of the virtual key input unit excluding the boundary lines, the characters, and the symbols of the respective keys are clarified. Then, the transparent skin input unit 23 of the virtual key input unit is generated. In other words, the transparent skin input unit 23 is generated by computer graphic processing which may obtain an effect of printing key boundary lines and characters on a transparent glass panel.

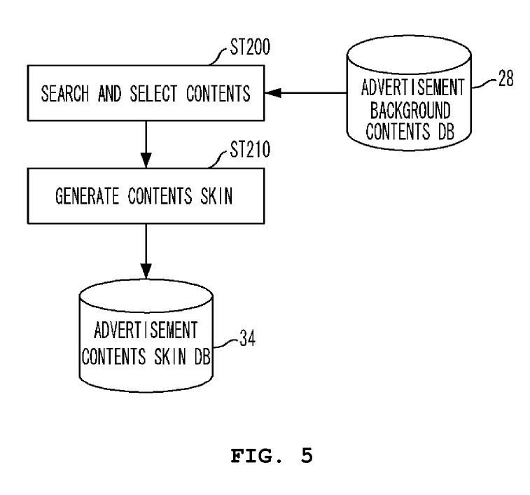

FIG. 5 shows a process of generating an advertisement contents skin from advertisement contents. Referring to FIG. 5, the process is started by searching advertisement contents at step ST200. At this time, the advertisement contents DB 28 is referred to. The searching of the advertisement contents may be performed by using attributes of the respective contents, such as contents name, producer, and provider. After the searching of the advertisement contents, the searched contents are displayed on the display screen of the user's smart phone. When the user selects advertisement contents, the advertisement contents skin generator 32 generates an advertisement contents skin 33 at step ST210. The generated advertisement contents skin is stored in the advertisement contents skin DB 34.

The advertisement contents skin generator 32 adjusts the selected contents according to the physical characteristics of the user's information communication terminal, that is, the size and resolution of the virtual keypad, and generates the advertisement contents skin 33. This process is carried out by a graphic software tool.

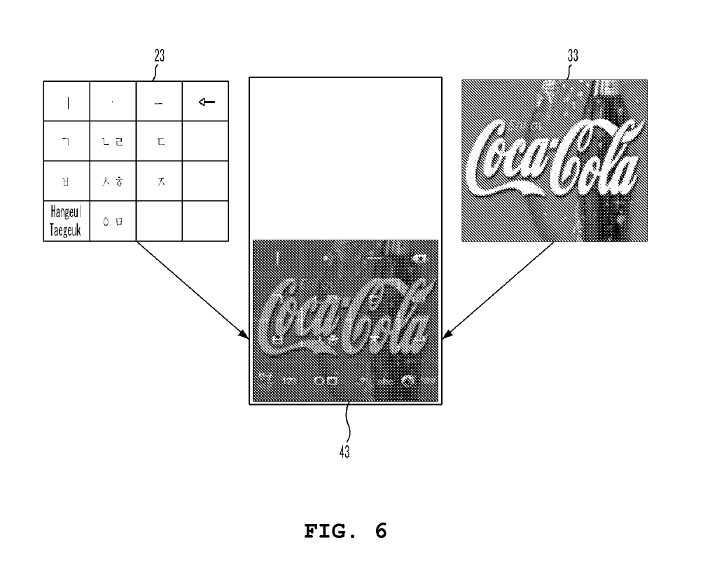

FIG. 6 shows a process of combining a transparent skin input unit and an advertisement contents skin. Referring to FIG. 6, it can be seen that the transparent skin input unit 23 generated through the process of FIG. 3 and the advertisement contents skin 33 generated through the process of FIG. 5 are combined to form the combined skin 43. The generation process of the combined skin 43 is performed as follows. First, the advertisement contents skin 33 is loaded into a virtual key input unit region of the smart phone 10, and the transparent skin input unit 23 is then loaded and combined with the advertisement contents skin 33. When the combined skin 43 is formed in such a manner, the virtual key input unit according to the embodiment of the present invention is completely formed. The virtual key input unit is displayed on the lower region 12 of the smart phone 10 as illustrated in FIG. 1.

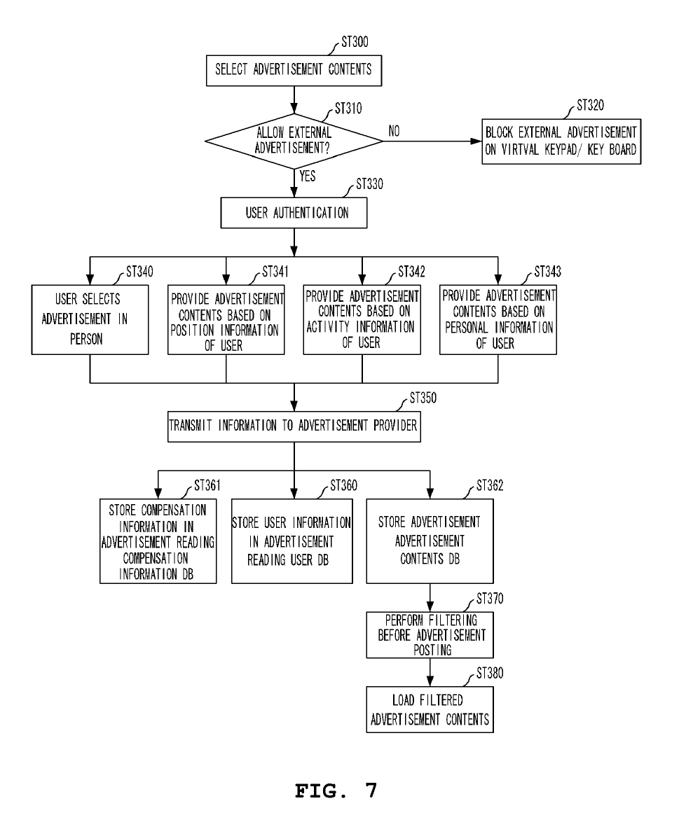

FIG. 7 is a flow chart showing a process of selecting advertisement contents. Referring to FIG. 7, an advertisement contents selection process is performed at step ST300, and whether the user of the smart phone 10 allows an external advertisement or not is confirmed at step ST310. When the user does not allow an external advertisement, an external advertisement is blocked at step ST320. In this case, the user may load a desired background image into the display region of the virtual key input unit. The background image may include contents containing picture, photograph, video, or animation, which are taken or created by the user.

When the user allows an external advertisement, the external advertisement is provided after a user authentication step ST330. The external advertisement is provided from the advertisement provider server 70. The external advertisement may be provided in various manners. Here, the user may receive the external advertisement by selecting any one of methods which will be described below or according to a combination of two or more methods.

First, the user may select an advertisement in person at step ST340. For example, meta data such as new books, records, movies, and clothes are provided to the user. Then, the user selects meta data of an advertisement which the user wants to read.

Second, advertisement contents may be provided based on the position information of the user, at step S341. For example, a GPS module provided in the smart phone 10 transmits the current position of the user to the advertisement provider server 70. The advertisement provider server 70 collects the position information of the user and provides advertisement contents related to the position information. For example, the advertisement provider server 70 may provide information on famous restaurants positioned within a 1-km radius of the user's current position, in an advertisement contents form.

Third, advertisement contents may be provided based on activity information of the user, at step S342. For example, the user stores information on shopping records or work in the smart phone 10, and the information is transmitted to the advertisement provider server 70 by user authentication. The advertisement provider server 70 provides related advertisement contents by referring to the activity information of the user. For example, when the user frequently goes clothes shopping, the advertisement provider server 70 provides the user with a clothes shopping advertisement in an advertisement contents form.

Fourth, advertisement contents may be provided based on personal information of the user, at step ST343. For example, personal information on the occupation, age, sex, family background, and income of the user is transmitted to the advertisement provider server 70 by user authentication. The advertisement provider server 70 provides advertisement contents related to the personal information of the user by referring to the personal information. For example, when the user does not own a car or has recently sold his/her car, the advertisement provider server 70 provides the user with a car advertisement in an advertisement contents form.

The four steps ST340 to ST343 may be performed in parallel or only one of the steps ST340 to ST343 may be performed by a user's selection. Furthermore, when the user selects any one type, the selected type and advertisement contents information are transmitted to an advertisement provider at step ST350. Such an advertisement contents providing method may provide an environment in which the user selects an advertisement in an interactive manner with advertisement providers.

The advertisement provider server 70 stores the information of the user reading the advertisement in the advertisement reading user DB 54 at step ST360, and stores compensation information on the advertisement reading in the advertisement reading compensation information DB 56 at step ST361. Furthermore, the advertisement provider server 70 stores the advertisement contents selected by the user in the advertisement contents DB 28 at step S362. In some cases, the advertisement provider server 70 may generate an advertisement contents skin and operate an advertisement contents skin DB 34, before the step ST362. In this case, the advertisement contents skin is stored in the advertisement contents skin DB 34 at the step ST362.

Then, before the advertisement contents or advertisement contents skin is provided to the user, filtering is performed at step S370. During the filtering, the contents are searched and processed by using the attribute information of the advertisement contents DB 28. For example, since a search word such as ‘porno’ corresponds to a value of an advertisement area as attribute information, advertisement posting may be rejected in a state where adult verification is failed. Then, the filtered advertisement contents or advertisement contents skin is loaded into the information communication terminal of the user, at step ST380.

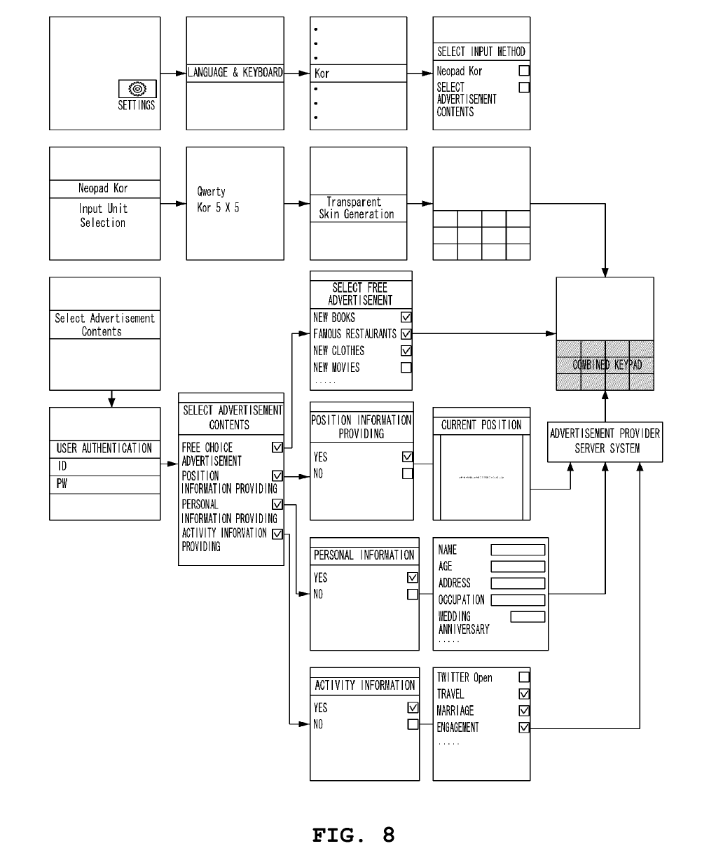

FIG. 8 illustrates an example in which the method for providing advertisement contents of a virtual key input device according to the embodiment of the present invention is performed in an Android-based smart phone. FIG. 8 obviously illustrates a process in which a background advertisement of a virtual key input device is provided according to the embodiment of the present invention. Referring to FIG. 8, a user touches a ‘Settings’ widget provided by the smart phone 10 to activate a language and keyboard selection window. Then, the user selects ‘Kor’ representing Korean from the selection window.

When the user selects ‘Neopad Kor’ from an input method selection window, an input unit selection process is started as illustrated in a second line of FIG. 8. During the input unit selection process, when the user selects a Qwerty and 5×5 Korean keypad, the transparent skin input unit generator 22 loads a 2D transparent skin input unit 23 onto the screen.

Meanwhile, when the user selects ‘Select Advertisement Contents’ from the input method selection window, an advertisement contents skin selection process is started as illustrated in a third line of FIG. 8. First, a user authentication process is performed as illustrated in a fourth line of FIG. 8. The user inputs his/her ID and password so as to pass through an authentication procedure. Then, the user selects an advertisement item from the advertisement contents selection window. Here, although not illustrated, the user may reject posting of loan advertisements or obscene advertisements such as porno. In this case, the user may not check metadata of the corresponding advertisement item. Then, the advertisement contents of the advertisement item which is not checked are not posted.

When the user selects ‘Free Choice Advertisement’, a user-customized advertisement contents providing service is performed. The user may select an advertisement item among various advertisement items such as new books, famous restaurants, new clothes, and new movies. Then, the user gets into sub-categories of the selected advertisement item, and finally selects advertisement contents or an arbitrary advertisement item. Subsequently, a virtual key input unit, into which the advertisement contents are loaded as a background image through the advertisement contents skin generation process and the combined skin formation process, is displayed on the smart phone 10.

When the user selects ‘Position Information Providing’, a window asking the user to provide position information is activated. In this case, when the user selects ‘YES’, the position information of the user is transmitted to the advertisement provider server 70. The advertisement provider server 70 provides advertisement contents related to the position information of the user.

When the user selects ‘Personal Information Providing’, a window asking the user to provide personal information is activated. In this case, when the user selects ‘YES’, the personal information of the user is transmitted to the advertisement provider server 70. The advertisement provider server 70 provides advertisement contents related to the personal information of the user.

When the user selects ‘Activity Information Providing’, a window asking the user to provide activity information is activated. In this case, when the user selects ‘YES’, the activity information of the user is transmitted to the advertisement provider server 70. The advertisement provider server 70 provides advertisement contents related to the activity information of the user.

The method for providing advertisement contents in a user-customized manner or interactive manner may solve the problem of current banner advertisements which are provided in a one-sided manner regardless of users' intentions. Furthermore, the advertisement provider may further increase an advertisement effect by providing an advertisement necessary for users, and a user may read an advertisement selected by the user and obtain a variety of product information and so on. At this time, the technique for filtering obscene sites by searching attributes of advertisement contents may be implemented by a currently-commercialized filtering technique, and the technique for recognizing a user's intention according to the morpheme processing technique may also be implemented by a well-known technique.

Meanwhile, the method in which the advertisement provider provides advertisement contents or an advertisement contents skin to the virtual key input unit of the user may be divided into two methods. The two methods may include a real-time streaming method and an offline streaming method. In the former, advertisement contents are downloaded from the advertisement contents skin DB 34 according to the real-time streaming method. The real-time stream method has an advantage in that a user does not need to allocate a separate storage space, but may cause a traffic jam when a wireless network is congested. In the latter, advertisement contents are downloaded in a memory area of a user's information communication terminal at a proper time, and posted when the user requests the advertisement contents. In this method, the advertisement contents are downloaded to the user during a time zone where the wireless network is not relatively busy, but a storage space is required to store the advertisement contents. Therefore, when the latter method is adopted, a proper compensation needs to be added to the user.

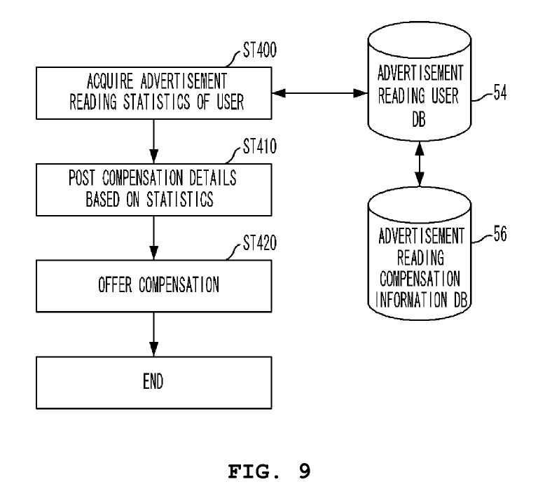

FIG. 9 is a flow chart showing a process of offering a reward in compensation for advertisement reading. The advertisement reading compensator 52 serves to offer a reward in compensation for user's reading an advertisement. The advertisement reading compensator 52 searches the advertisement reading user DB 54 and acquires advertisement reading statistics of the user during a predetermined period, at step ST400. At this time, the advertisement reading user DB 54 is a DB system which stores and manages data attributes for each user. The data attributes may include a read advertisement detail, a compensation detail, a compensation date and so on. Furthermore, in order to acquire information on the compensation details or the like, the advertisement reading compensator 52 refers to the advertisement reading compensation information DB 56. The advertisement reading compensation information DB 56 is a DB system which stores and manages data attributes for each advertisement contents. The data attributes may include an advertisement contents name, a read advertisement, an advertisement reading number, and a compensation method.

The advertisement reading compensator 52 displays compensation details on the smart phone of the user, based on the statistics, at step ST410. Then, the advertisement reading compensator 52 offers a compensation after a user's approval, at step ST420. At this time, the compensation for the user may include a discount coupon, cash, a prize, a discount, and a point. Furthermore, the user may select any one of the compensation methods.

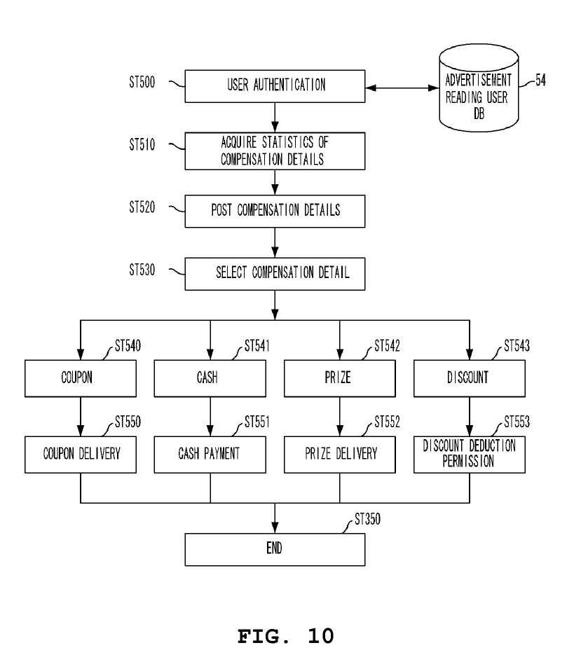

FIG. 10 is a flow chart showing a process in which the user selects a compensation method. Referring to FIG. 10, the process is started by a user authentication step ST500. The authentication information of the user is stored in and managed by the advertisement reading user DB 54. Then, statistics of user compensation details are acquired at step ST510, and posted on the user's smart phone at step ST520. The above-described steps are performed in the same manner as described with reference to FIG. 9.

Subsequently, a process of causing the user to select a compensation method is performed at step ST530. At this time, the user may receive a coupon at step ST540, receive cash at step ST542, receive a prize at step ST543, or receive a discount at step ST544, according to the user's selection. Then, the subsequent steps are performed. For example, the subsequent steps may include coupon delivery at step ST550, cash payment at step ST551, prize delivery at step ST552, and discount deduction permission at step ST553.

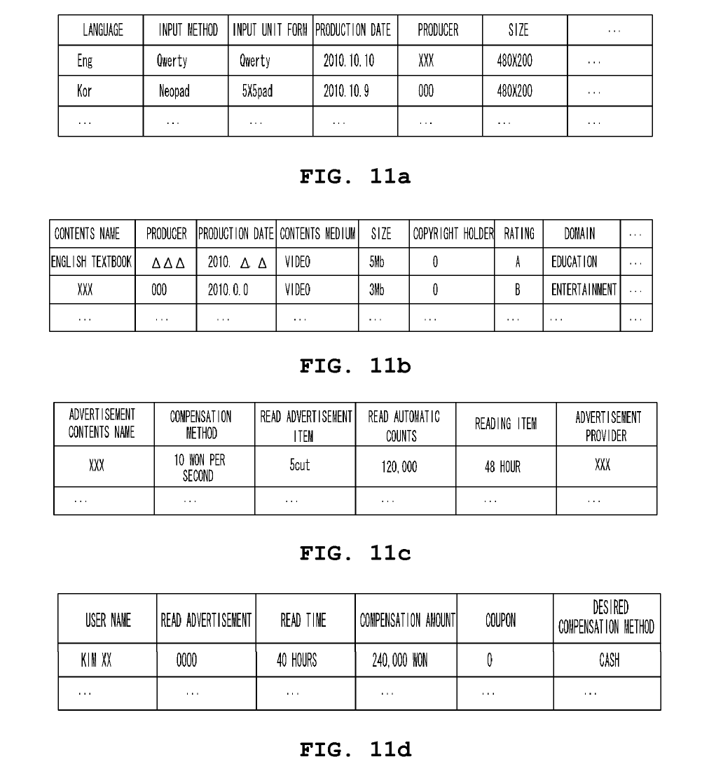

FIGS. 11A to 11D show memory tables including record attributes of the above-described DB systems. FIG. 11A shows the attributes and values of transparent skin input units stored in the transparent skin input unit DB 24. Referring to FIG. 11A, the attributes include a language, an input method, an input unit form, a creation date, a creator, a size and so on for each transparent skin input unit. FIG. 11B shows the attributes and values of advertisement contents skins stored in the advertisement contents skin DB 34. Referring to FIG. 11B, the attributes include an advertisement name, an advertisement producer, a production date, a contents media, a size, a copyright, a contents rating, a contents form and so on for each advertisement contents skin.

FIG. 11C shows the attributes and values of advertisement contents stored in the advertisement reading compensation information DB 56. Referring to FIG. 11C, the attributes include an advertisement contents name, a compensation method, a read automatic counts, a read advertisement item, a reading time, an advertisement provider and so on for each advertisement contents. FIG. 11D shows the attributes and values of users stored in the advertisement reading user DB 54. Referring to FIG. 11D, the attributes include a user name, a read advertisement, a reading time, a compensation amount, a compensation detail, a desired compensation method and so on for each user.

The data attributes stored in the respective DB systems as shown in FIGS. 11A to 11D are used for searching and generating a transparent skin input unit, searching and generating an advertisement contents skin, acquiring statistics for offering a compensation for advertisement reading, or offering a compensation to a user.

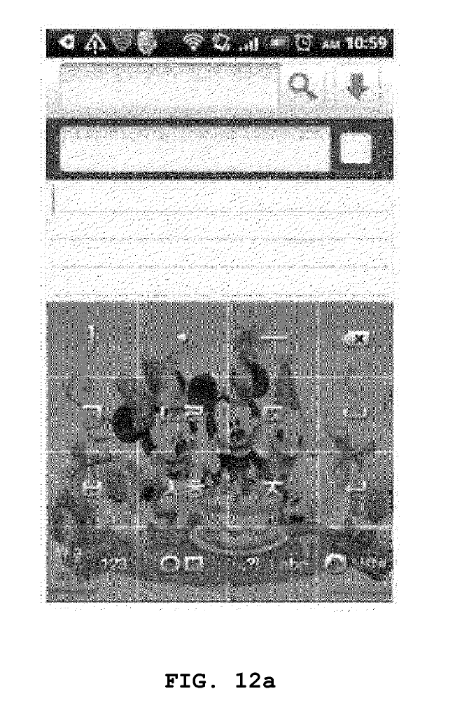

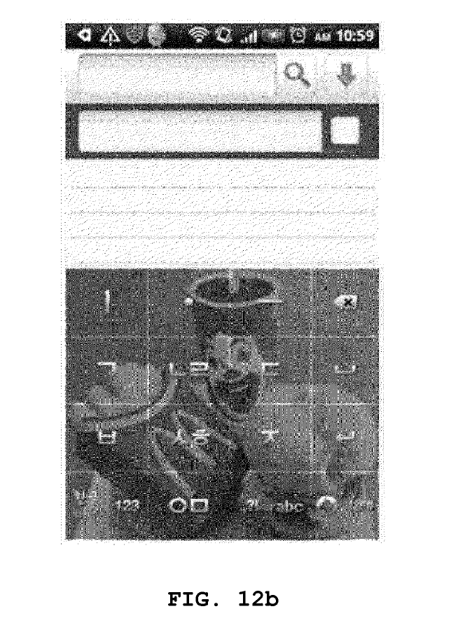

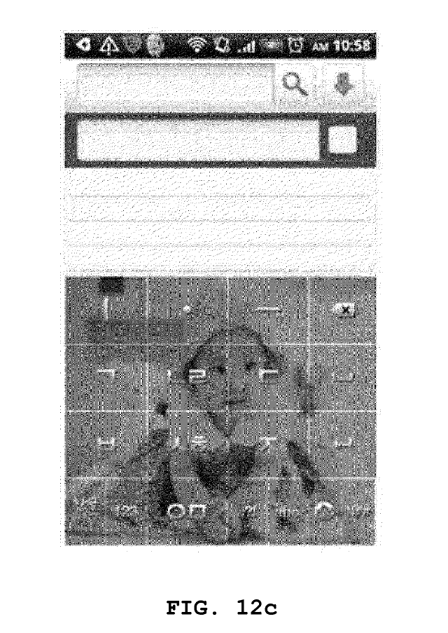

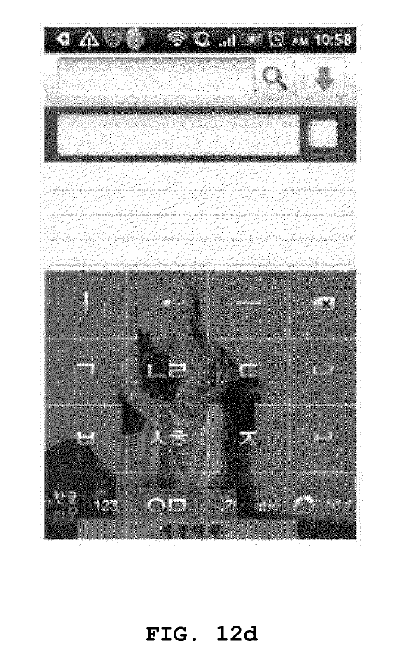

FIGS. 12A to 12D show examples in which advertisement contents skins are utilized as background images of a virtual key input unit. FIG. 12A shows an example in which advertisement contents of a character business are provided as a background image, FIGS. 12B and 12C shows examples in which the advertisement contents of famous brands are provided as background images, and FIG. 12D shows an example in which the advertisement contents are implemented in a dial keypad of a smart phone. As the background space of the virtual key input device, which is an unused space, is utilized for business purposes, the TUI based on the latest UI technology and the UX technology aimed for realizing users' latent demands may be merged, and the space utilization may be increased to create a new business model.

While the present invention has been described with respect to the specific embodiments, it will be apparent to those skilled in the art that various changes and modifications may be made without departing from the spirit and scope of the invention as defined in the following claims.

1. A method for providing a background advertisement of a virtual key input device, which provides a background advertisement to a virtual key input device on an information communication terminal supporting a touch user interface (UTI), the method comprising:
generating a virtual key input unit;
providing an advertisement contents skin as a background image of the virtual key input unit; and
offering a reward in compensation for user's reading an advertisement.

2. The method according to claim 1, wherein the generating of the virtual key input unit comprises:
selecting a virtual key input unit; and
generating a transparent skin input unit based on the selected virtual key input unit.

3. The method according to claim 2, wherein the selecting of the virtual key input unit comprises:
selecting a language of the virtual key input unit;
selecting a key input method; and
selecting a form of the virtual key input unit.

4. The method according to claim 2, wherein the generating of the transparent skin input unit comprises:
generating the selected virtual key input unit into a two-dimensional (2D) graphic frame;
allocating character keys onto the 2D graphic frame and arranging the allocated character keys; and
generating the 2D graphic frame having the character keys arranged therein into the transparent skin input unit.

5. The method according to claim 4, wherein further comprising constructing a transparent skin input unit DB configured to store the transparent skin input unit.

6. The method according to claim 5, wherein the constructing of the transparent skin input unit DB comprises:
allocating a data attribute to each transparent skin input unit, the data attribute comprising one or more of language, input method, input unit form, production date, producer, and size; and
storing the transparent skin input unit in the transparent skin input unit DB according to the data attribute.

7. The method according to claim 1, wherein the providing of the advertisement contents skin as the background image of the virtual key input unit comprises:
selecting advertisement contents;
generating the selected advertisement contents into an advertisement contents skin of the virtual key input unit; and
combining the virtual key input unit and the advertisement contents skin.

8. The method according to claim 7, wherein the combining of the virtual key input unit and the advertisement contents skin comprises:
loading the advertisement contents skin into a virtual key input unit region of a display screen of the information communication terminal; and
loading a transparent skin input unit of the virtual key input unit, and combining the loaded transparent skin input unit and the advertisement contents skin.

9. The method according to claim 7, wherein the generating of the selected advertisement contents into the advertisement contents skin of the virtual key input unit comprises:
standardizing the selected advertisement contents according to the size of the virtual key input unit;
adjusting the resolution of the advertisement contents according to the resolution of the user's information communication terminal; and
generating the advertisement contents into the advertisement contents skin of the virtual key input unit.

10. The method according to claim 9, further comprising constructing an advertisement contents skin DB configured to store the advertisement contents skin.

11. The method according to claim 10, wherein the constructing of the advertisement contents skin DB comprises:
allocating a data attribute to each advertisement contents, the data attribute comprising one or more of advertisement name, advertisement producer, production date, contents media, size, copyright, contents form, and contents rating; and
storing the advertisement contents skin in the advertisement contents skin DB according to the data attribute.

12. The method according to claim 7, wherein the advertisement contents comprise a multimedia file containing pictures, photographs, animations, videos, or 3D video.

13. The method according to claim 7, wherein the selecting of the advertisement contents comprises:
confirming whether or not the user allows external advertisements to be posted on the virtual key input unit of the information communication terminal;
receiving verification of the user; and
providing, by an advertisement provider server, advertisement contents to the user.

14. The method according to claim 13, wherein the providing of the advertisement contents to the user comprises a streaming method by a wired/wireless medium and a download method by a storage medium.

15. The method according to claim 13, further comprising any one or a combination of two or more of:
selecting, by the user, advertisement contents provided by the advertisement provider server;
providing, by the advertisement provider server, advertisement contents based on position information of the user;
providing, by the advertisement provider server, advertisement contents based on activity information of the user; and
providing, by the advertisement provider server, advertisement contents based on personal information of the user.

16. The method according to claim 15, wherein the selecting of the advertisement contents provided by the advertisement provider server comprises:
posing an advertisement area and contents in a metadata table form on the information communication terminal of the user; and
selecting, by the user, metadata containing an advertisement area and contents.

17. The method according to claim 15, wherein the providing of the advertisement contents based on the position information of the user comprises:
collecting the position information from the information communication terminal of the user; and
providing advertisement contents related to the position information to the user.

18. The method according to claim 15, wherein the providing of the advertisement contents based on the activity information of the user comprises:
collecting the activity information from the information communication terminal of the user; and
providing advertisement contents related to the activity information to the user.

19. The method according to claim 15, wherein the providing of the advertisement contents based on the personal information of the user comprises:
collecting the personal information from the information communication terminal of the user; and
providing advertisement contents related to the personal information to the user.

20. The method according to claim 1, wherein the offering of the reward in compensation for user's reading the advertisement comprises:
constructing an advertisement reading user DB configured to store information of the user which reads the advertisement; and
constructing an advertisement reading compensation information DB configured to store compensation information which is to be provided to the user who reads the advertisement.

21. The method according to claim 20, wherein the constructing of the advertisement reading user DB comprises allocating a data attribute to each user, the data attribute comprising one or more of a reading advertisement detail, a compensation detail, and a compensation date.

22. The method according to claim 20, wherein the constructing of the advertisement reading compensation information DB comprises allocating a data attribute to each advertisement contents, the data attribute comprising one or more of an advertisement contents name, a read advertisement item, an advertisement reading number, a read date, and a compensation method.

23. The method according to claim 20, wherein the offering of the reward in compensation for user's reading the advertisement further comprises:
acquiring statistics for advertisement contents read by the user;
posting compensation details on the information communication terminal of the user; and
offering a compensation to the user.

24. The method according to claim 23, wherein the posting of the compensation details comprises posting a plurality of compensation types and confirming a user's selection.

25. The method according to claim 24, wherein the plurality of compensation types comprise two or more of coupon, cash, prize, and discount.

26. A system for providing a background advertisement of a virtual key input device, which provides a background advertisement to a virtual key input device on an information communication terminal supporting a TUI, the system comprising:
a transparent skin input unit generator configured to generate a virtual key input unit into a transparent skin input unit;
an advertisement contents skin generator configured to generate advertisement contents into an advertisement contents skin; and
a skin combiner configured to combine the transparent skin input unit and the advertisement contents skin.

27. The system according to claim 26, wherein the transparent skin input unit generator generates the virtual key input unit into a 2D graphic frame, and allocates character keys onto the 2D graphic frame to generate the transparent skin input unit.

28. The system according to claim 27, further comprising a transparent skin input unit DB configured to store and manage the transparent skin input unit such that the transparent skin input unit has a data attribute comprising one or more of language, input method, input unit form, production date, producer, and size.

29. The system according to claim 26, wherein the advertisement contents skin generator generates the advertisement contents into a background advertisement contents skin of the virtual key input unit.

30. The system according to claim 29, wherein the advertisement contents skin generator generates the background advertisement contents skin by standardizing the advertisement contents according to the size of the virtual key input unit and adjusting the resolution of the advertisement contents according to the resolution of the information communication terminal of the user.

31. The system according to claim 29, further comprising an advertisement contents skin DB configured to store and manage the advertisement contents skin such that the advertisement contents skin has a data attribute comprising one or more of advertisement name, advertisement producer, production date, contents media, size, copyright, contents form, and contents rating.

32. The system according to claim 26, wherein the advertisement contents comprise a multimedia file containing pictures, photographs, animations, videos, or 3D videos.

33. The system according to claim 26, wherein the skin combiner loads the advertisement contents skin into a virtual key input unit region of a display screen of the information communication terminal, loads the transparent skin input unit, and combines the transparent skin input unit and the advertisement contents skin.

34. The system according to claim 33, further comprising a combined skin DB configured to store and manage the combined skin formed by the skin combiner.

35. The system according to claim 26, further comprising:
an advertisement provider server configured to provide the advertisement contents; and
an advertisement reading compensator provided in the advertisement provider server and configured to offer a reward in compensation for user's reading an advertisement.

36. The system according to claim 35, wherein the advertisement provider server provides the advertisement contents to the user using a streaming method by a wired/wireless medium or a download method by a storage medium.

37. The system according to claim 35, wherein the advertisement provider server comprises a user-customized advertisement contents generator configured to enable the user to select advertisement contents.

38. The system according to claim 35, wherein the advertisement provider server provides advertisement contents based on any one or a combination of two or more of position information, activity information, and personal information of the user.

39. The system according to claim 35, wherein the advertisement reading compensator acquires statistics for advertisement contents read by the user and offers a compensation corresponding to the statistics.

40. The system according to claim 39, wherein the advertisement reading compensator decides one or more compensation types among coupon, cash, prize, and discount according to the user's selection.

41. The system according to claim 35, further comprising an advertisement reading user DB configured to store and manage advertisement reading information of the user such that the advertisement reading information has a data attribute comprising one or more of read advertisement detail, compensation detail, and compensation date.

42. The system according to claim 35, further comprising an advertisement reading compensation information DB configured to store and manage compensation information for advertisement reading such that the compensation information has a data attribute comprising one or more of advertisement contents name, read advertisement item, advertisement reading number, read date, and compensation method.
